(19) United States
(12) Patent Application Publication
(10) Pub. No.: US 2015/0150275 A1
(43) Pub. Date: Jun. 4, 2015

(54) Methods For Processing Acid Whey

(71) Applicant: The United States of America, as represented by the Secretary of Agriculture, Washington, DC (US)

(72) Inventors: Charles I. Onwulata, Cheltenham, PA (US); Sudarsan Mukhopadhyay, Dresher, PA (US); Audrey E. Thomas-Gahring, Harleysville, PA (US)

(21) Appl. No.: 14/556,562

(22) Filed: Dec. 1, 2014

Related U.S. Application Data
(60) Provisional application No. 61/911,078, filed on Dec. 3, 2013.

(51) Int. Cl. A23C 21/02

(52) U.S. Cl. CPC A23C 21/023

(57) ABSTRACT

Methods for processing acid whey, involving treating acid whey solution with α-galactosidase and/or β-galactosidase, at a pH of about 3.2 to about 5.2 for about 20 minutes to about 16 hours at about 20° C. to about 60° C. to produce an acid whey solution containing at least about 40% less lactose than the original acid whey solution, filtrating the tempered acid whey solution to form a retentate containing proteins and a permeate containing lactose and residual proteins, recovering lactose from the permeate, optionally drying the retentate to form acid whey powder, and optionally texturizing the acid whey powder.

### REFERENCE TO RELATED APPLICATION

This application claims the benefit of U.S. Provisional Application No. 61/911,078, filed 2 Dec. 2013, which is incorporated herein by reference in its entirety.

### BACKGROUND OF THE INVENTION

Disclosed are methods for processing acid whey, involving treating acid whey solution with α-galactosidase and/or β-galactosidase, at a pH of about 3.2 to about 5.2 for about 20 minutes to about 16 hours at about 20° C. to about 60° C. to produce an acid whey solution containing at least about 40% less lactose than the original acid whey solution, filtrating the tempered acid whey solution to form a retentate containing proteins and a permeate containing lactose and residual proteins, recovering lactose from the permeate, optionally drying the retentate to form acid whey powder, and optionally texturizing the acid whey powder.

Food technology has provided the knowledge and tools that transformed “sweet” whey proteins, once waste byproducts of the cheese making industry, into a multi-billion dollar global commodity (Smithers, G. W., International Dairy journal, 18(7): 695-704 (2008)). Disposal of all whey proteins was an environmental hazard through the 1960s when processes were developed for the disposal of whey from cheese making (Wix, P., and M. Woodbine, Daily Science Abstracts, 20(7); 539-548 (1958); Wix, P., and M. Woodbine, Dairy Science Abstracts, 20(8): 623-634 (1958)). Modern processing was developed for the use of “sweet” whey, the products of cheeses made using rennet coagulation (Marwaha, S. S., and J. F. Kennedy, Int. J. Food Sci. Technol., 23: 323-336 (1988); Huffman, L. M., Food Technol., 50(2): 49-52 (1996)). In contrast, “acid” whey, the byproducts of cheese or Greek-type yoghurt making through direct acidification, is a very sticky hard-to-process whey and was currently underutilized even as late as 2013.

Acid Whey contains all the constituents, in the same relative proportion, as in whey (Gonzalez Siso, M. I., Bioresource Technology, 57: 1-11 (1996) except for higher ash content. Acid whey is safe for human consumption, meeting all provisions of the U.S. Federal Food, Drug, and Cosmetic Act. Acid whey is composed of lactose (61.0-70.0%), protein (11.0-13.5%), ash (9.8-12.3%), moisture (3.5-5.0%), and fat (0.5-1.5%); this is the same as sweet whey (Mawson, A. J., Biores. Technol., 47: 195-203 (1994)). However, the use of acid whey is currently hampered by its hygroscopicity and stickiness.

Acid whey (AW) is very difficult to process which is why it is currently dumped on farm lands or fed to animals. The U.S. alone produced over 552 million pounds of dry whey products in 2008; sweet whey used for human consumption was about 400 million pounds, but only 2.5 million pounds were acid whey powders. U.S. production of whey proteins grew from 6 million pounds in 1970 to 1.5 billion pounds in 2006. Worldwide, the market for whey protein products is estimated at $1.4 billion. Various measures are used to dry whey proteins for human consumption (Huffman, 1996), and for animal feeds using different drying methods (Nessmith, W. B., Jr., Swine Health Prod., 5: 145-149 (1997)).

Other modalities were developed for utilization of whey proteins, including fermentation of acid whey with Aspergillus niger to create citric acid (Somkuti, G. A., and M. M. Bencivengo, Developments in Industrial Microbiology, 22: 557-563 (1981)); biogas, ethanol, and single cell protein (Gonzalez Siso 1996); methane and ethanol (Mawson 1994). Modification of whey medium can be achieved using high levels of alcohols (>70%) to crystallize, precipitate and separate lactose (Leviton, A., and A. Leighton, Ind. Eng. Chem., 30 (11): 1305-1311 (1938)). Acid whey can be modified using sugar alcohols such as sorbitol or with anionic hydrocolloids such as carboxymethylcellulose (Hansen, P. M. T., et al., Journal of Dairy Science, 540: 830-834 (1971).

For the most part, handling and processing of acid whey has remained problematic due to the “sticky” nature of the proteins and the complexes with lactose (Feller, S. M., and M. Lewitzky, Cell Communication and Signaling, 10: 15 (1-2)(2012)), which computational cherish has shown to be formed into adhesives. For increased utility, specific bonds and interactions are currently manipulated by changing solvent temperature, pH and electrostatic charges (Van der Leeden, M. C., et al., Journal of Biotechnology, 79: 211-221 (2000)). Further refinement of the acid whey fractions can be achieved using a series of steps including clarification to remove fats, precipitation of α-lactalbumin at pH <4.0, separation of β-lactoglobulin followed by microfiltration (Gésan-Guiziou, G., et al., J. Dairy Res., 66: 225-236 (1999)).

We have developed texturization technologies that makes it easy to incorporate large amounts of whey proteins into different products.

### SUMMARY OF THE INVENTION

Disclosed are methods for processing acid whey, involving treating acid whey solution with α-galactosidase and/or β-galactosidase, at a pH of about 3.2 to about 5.2 for about 20 minutes to about 16 hours at about 20° C. to about 60° C. to produce an acid whey solution containing at least about 40% less lactose than the original acid whey solution, filtrating the tempered acid whey solution to form a retentate containing proteins and a permeate containing lactose and residual proteins, recovering lactose from the permeate, optionally drying the retentate to form acid whey powder, and optionally texturizing the acid whey powder.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1a shows percentage of Lactose concentration that can be measured in solution in a pH 6 system through YSI analysis as described below.

FIG. 1b shows percentage of Lactose concentration that can be measured in solution in a natural pH (4.2) system through YSI analysis as described below.

FIG. 2 shows rate of lactose hydrolysis in acid whey as described below.

FIG. 3 shows electrophoresis of Acid Whey and treated acid whey as described below.

FIG. 4 shows a general flow chart of the method as described below.

### DETAILED DESCRIPTION OF THE INVENTION

Disclosed are methods for processing acid whey, involving treating acid whey solution with α-galactosidase and/or β-galactosidase, at a pH of about 3.2 to about 5.2 for about 20 minutes to about 16 hours at about 20° C. to about 60° C. to produce an acid whey solution containing at least about 40% less lactose than the original acid whey solution, filtrating the tempered acid whey solution to form a retentate containing proteins and a permeate containing lactose and residual proteins, recovering lactose from the permeate, optionally drying the retentate to form acid whey powder, and optionally texturizing the acid whey powder.

We have developed methods of creating acid whey products (AWP) by combining four unique processes which include enzymatic saccharification (ES), functional modifications (deStik Process), optional drying (e.g., spray drying, drum dryers, roller dryers), and optional texturization processes. The enzymatic saccharification (ES) process involves treating acid whey solution with α- and/or β-galactosidase at about 20° C. to about 60° C. (e.g., 20-60° C.; preferably about 30° C. to about 50° C. (e.g., 30-50° C.), more preferably about 35° C. to about 45° C. (e.g., 35-45° C.), most preferably about 40° C., (e.g., 40° C.) for about 20 minutes to about 16 hours (e.g., 20 minutes-16 hours, or any range within the range of about 20 minutes to about 16 hours), and at a pH of about 3.2 to about 5.2. (e.g., 3.2-5.2; preferably about 4 to about 4.4 (e.g., 4-4.4), more preferably about 4.2 (e.g., 4.2)); this process scaled-up included the use of immobilized enzymes (e.g., immobilized on glass beads) and selective microfiltration ceramic sieves) generally about 10 to about 300 Microns (e.g., 10-300 microns). Treatment with enzyme(s) produces an acid whey solution containing at least about 40% less lactose (e.g., at least 40% less lactose) to about 80% less lactose (e.g., at least 80% less lactose) than the original acid whey solution, or any range within the range of at least about 40% less lactose to about 80% less lactose. Generally, prior to addition of enzyme(s), the initial acid whey solution is tempered at a tempering rate of about 2° C./min until the desired temperature (e.g., about 20° C. to about 60° C.) is reached. Treatment with enzyme(s) results in the deStik product which is a thermodynamically unstable colloid which can be optionally dried into AWP powder in a dryer (e.g., spray dryer at an inlet temperature of about 185° to about 195° C. (e.g., 185° to 195° C.) and outlet of about 170° to about 185° C. (e.g., 170° to 185° C.)), and optionally texturized (Texturized Acid Whey Products) under extrusion conditions of low temperatures to avoid completely denaturing the proteins but with sufficient shear to stretch or modify the proteins using the process described in U.S. Pat. No. 7,081,010 B2); in conjunction, AWP sugar-rich products can be created using the process described in U.S. Patent Application Publication No. 20080280006.

Lactose recovery from the permeate generally involves a protein removal process such as further treatment of the permeate stream with 0.5 N HCl and heating to about 40° to about 90° C. (e.g., 40° to 90° C.) to coagulate the residual proteins, and allow for filtration of lactose crystals (Akbari, Z., et al., International Journal of Food Engineering, 8 (3) 1-7 (2012).

Extrusion processing of whey proteins transforms them into totally new structures with entirely new functional properties. For example, it is possible to make expandable whey protein foams—whey cake using texturized whey proteins (TWP). TWP is more soluble and digestible than spray dried whey powder. Animal model studies with TWP showed better nitrogen conversion and enhanced immune function. The future for whey proteins will depend on understanding the benefits of the new structural forms in the human digestion system.

The texturized ES treated acid whey adds value to a high volume low value byproduct: The demand for whey proteins for human consumption is on the increase world-wide. Worldwide sales for whey proteins were over $6 billion in 2008. Any process that adds value to a low-cost difficult to handle product, and that positions it in the human food chain where there is a high price and high demand, will enhance its value and ensure wide use. Over one hundred and fifty million pounds of whey-based products could be produced and marketed returning over $1 billion to the U.S. economy.

The acid whey solution containing at least about 40% less lactose than the original acid whey solution can generally be used, for example, in ice cream, yoghurt, and other dairy products, soups, and beverages. The acid whey powder can generally be used, for example, in baked goods, infant formulae, and confections. The texturized acid whey product can generally be used, for example, in snack products, ready-to-eat foods, and meats,

Unless defined otherwise, all technical and scientific terms used herein have the same meaning as commonly understood by one of ordinary skill in the art to which the invention belongs. The term “about” is defined as plus or minus ten percent; for example, about 100° C. means 90° C. to 110° C. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Optimization of the acid whey hydrolysis treatment was done in two steps. First, the lactase (e.g., β-galactosidase) enzyme concentration was optimized using powdered acid whey (dry acid whey, Friendship Dairies, Friendship, N.Y.) prepared in two concentrations with water; 7% solids (similar to sweet whey production) and 30% solids at their natural pH of 4.2. Lactose reduction of acid whey (starting material acid whey contains approximately 68% lactose by weight) was accomplished through hydrolysis using β-galactosidase (American Laboratories Incorporated, Omaha, Nebr.) with an activity of 5,000 ALU/g with a usage rate of 4 g lactose to 250 mg of β-galactosidase at 25° C. and 40° C. Hydrolysis treatment occurred in a beaker with continuous stirring in a water bath (Isotemp Model 2322, Fisher Scientific, Debuque, Iowa) set to the desired treatment temperature between 25° C. and 40° C. Five ml samples were removed at 5 minute intervals between 0 and 30 minutes, and 1 ml of 1M sodium carbonate were used to quench the reaction. Samples were analyzed using a 2700 YSI analyzer (Yellow Springs, Ohio) set up with lactose chemistry. Initial results showed that the enzyme concentration/activity was weak; the same experiment was repeated but the enzyme activity was doubled to 10,000 ALU/g. From this work it was determined that the enzyme activity of 10,000 ALU/g was optimal. It was also determined through this initial pass of optimization that the temperature of 25° C. was not optimal in encouraging hydrolysis but that 40° C. was optimal.

The second step of optimization was to choose the appropriate pH and solids concentration for hydrolysis of lactose. This was accomplished by preparing six concentrations of acid whey with water: 5% solids, 10% solids, 15% solids, 20% solids, 35% solids, and 40% solids at their natural pH of 4.2 and also at pH 6.0. The samples prepared to pH 6.0 were adjusted using 1.0 N NaOH. The acid whey solutions were mixed in a beaker with a stirrer in a water bath at 40° C. Samples were analyzed using a 2700 YSI analyzer set up with lactose chemistry to understand the lactose concentration in the solutions.

The third and final step of optimization was to choose the appropriate time for hydrolysis. This was accomplished by preparing three concentrations of acid whey with water: 7% solids, 10% solids, and 20% solids at their natural pH of 4.2. The acid whey solutions were mixed in a beaker with a stirrer in a water bath at 40° C. Lactase enzyme was added (10,000 ALU/g activity at usage ratio of 4 g lactose per 250 mg of lactase). Five ml samples were removed at 5 minute intervals between 0 and 60 minutes, and 1 ml of 1M sodium carbonate was used to quench the reaction. Samples were analyzed using a 2700 YSI analyzer set up with lactose chemistry.

Once the optimization of acid whey hydrolysis was completed, the process was scaled up for pilot plant processing. The optimal hydrolysis conditions were determined to be as follows: 20% acid whey concentration at natural pH of 4.2, enzyme activity of 10,000 ALU/g (4 g lactose per 250 mg of lactase), 40° C. for 30 minutes. To quench the reaction, the acid whey was heated to 60° C. and held for 15 min. The acid whey solution was ready to be used as is (or mixed with cornstarch, sugar, or butter) and/or then spray dried to make powders.

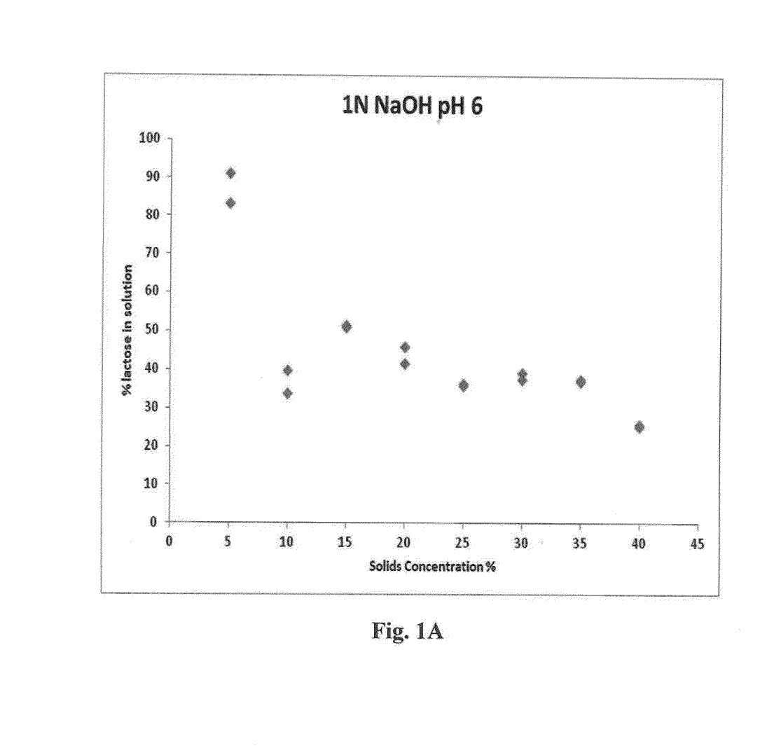

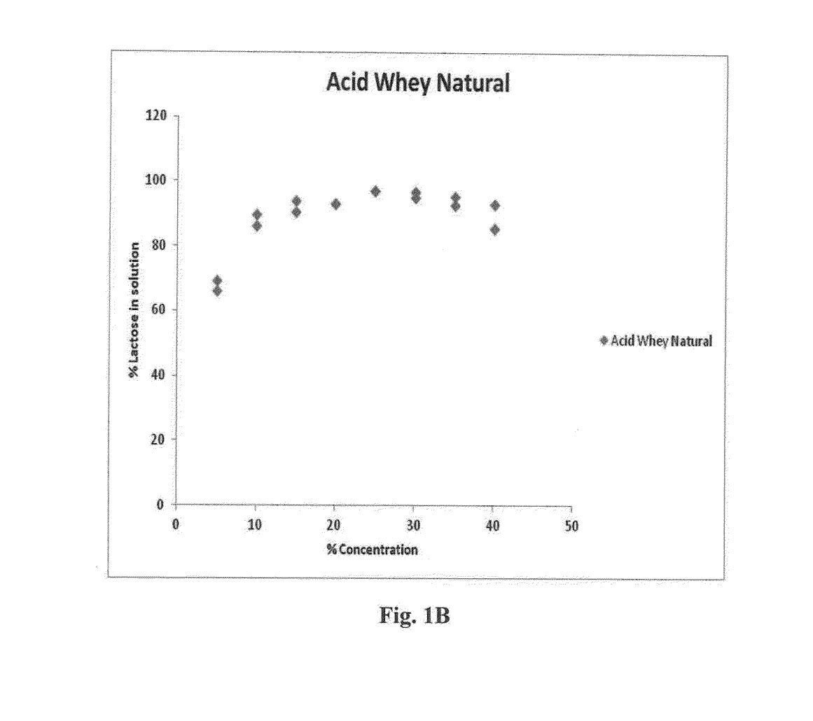

Results: FIGS. 1a and 1b showed that increasing the pH to 6 limited the amount of lactose that will go into solution and possibly inhibited the ability of the enzyme. FIG. 1b showed that using the natural acid whey pH of 4.2 was adequate and at 15-20% concentration most of the lactose was in solution. Since the pilot plant work required spray drying, 20% concentration was selected.

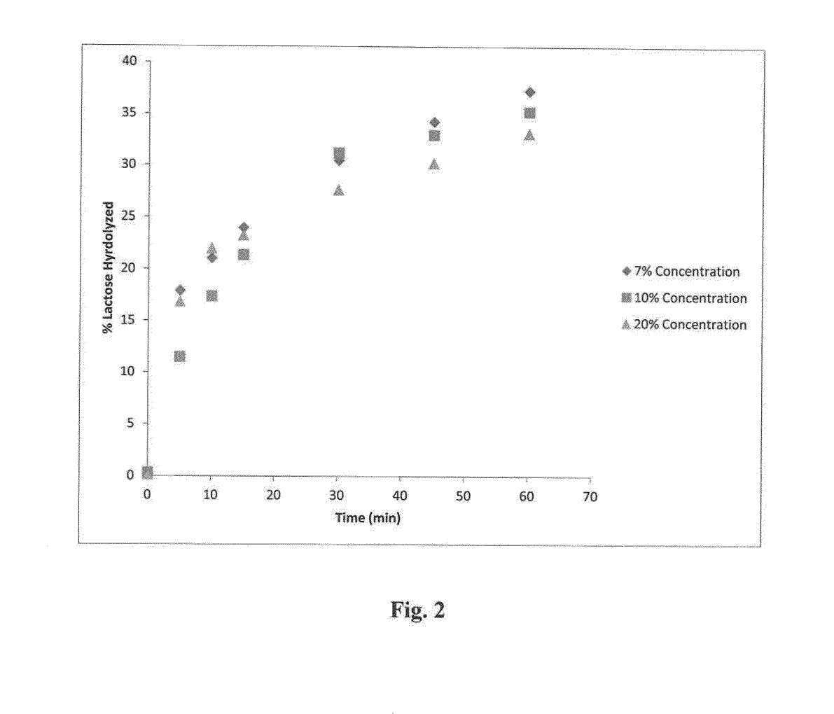

As seen in FIG. 2, after 30 minutes the lactose hydrolysis began to slow down and reach a steady state. For all three concentrations, over 30% of the lactose was hydrolyzed over 30 minutes. After 30 minutes, the increase in lactose hydrolysis was small. To save time and costs, 30 minutes was selected as the optimal time for lactose hydrolysis of acid whey.

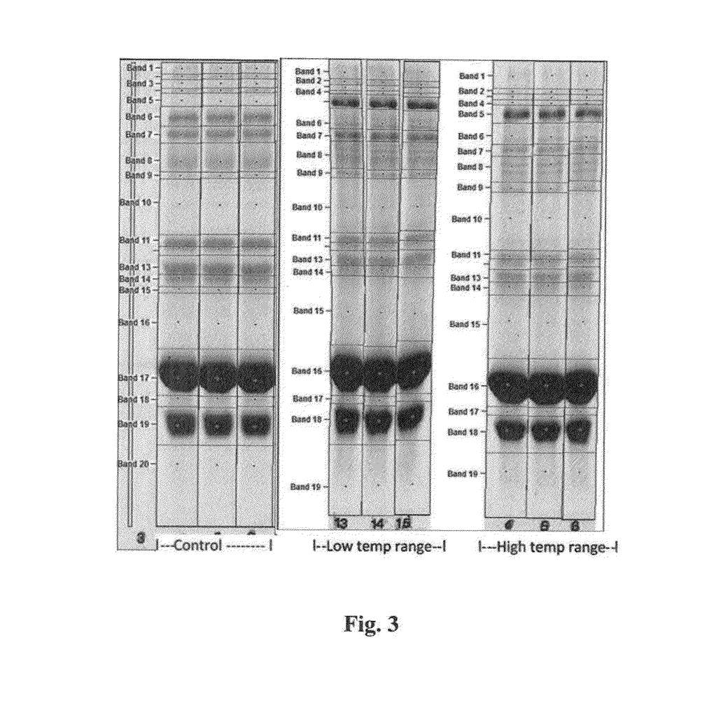

Increasing breakdown of lactose was accomplished by separating the lactose from the protein-lactose complex. A series of experiments were performed to determine what temperatures, combinations and concentrations of sorbitol, enzyme, and food grade acids (e.g., lactic acid, citric acid, malic acid, and acetic acid) would release the lactose for increased hydrolysis. These combinations included sorbitol at a use rate of 0-20% by weight, food grade acid (preferably citric acid) and temperature ranges from −4° C. to 90° C. Analysis by electrophoresis surprisingly showed distinct changes in the protein complex suggesting a release of lactose from β-lactoglobulin and α-lactalbumin as can be seen in the shift of concentration in both table 1 and FIG. 3.

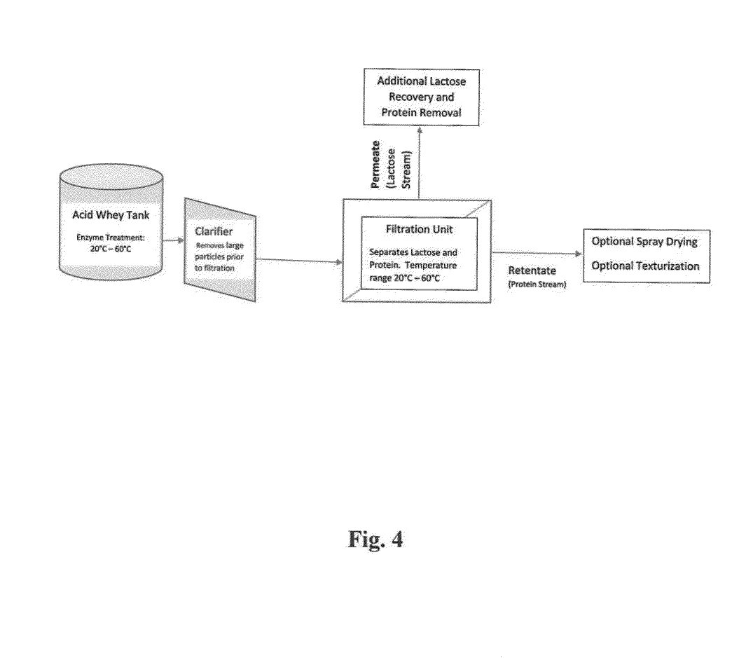

Additional work to separate the lactose and whey through a filtration device was able to concentrate the whey protein for further processing such as spray drying or as texturized whey products. Results from filtration showed excellent separation and concentration of protein and processing quantities for 5000 gallon process are shown in FIG. 4. The protein concentrate through separation in the pilot scale surprisingly resulted in a 65% protein concentrate and upon scale up is expected to become a more concentrated protein potentially reaching 90%.

The per pound value of acid whey is $0.50 compared to $3.00 to $5.00 per pound of ‘sweet whey concentrate’. The total worldwide sale of whey proteins was about $6 billion in 2008. The whey market in the U.S. is estimated at $4 billion but is growing approximately 20 percent every year. Our products made from waste proteins will play a big role in the financial, environmental, and health economy of the U.S.

All of the references cited herein, including U.S. patents, are incorporated by reference in their entirety.

Thus, in view of the above, there is described (in part) the following:

A method for processing acid whey, said method comprising (or consisting essentially of or consisting of) treating acid whey solution with at least one enzyme selected from the group consisting of α-galactosidase, β-galactosidase, and mixtures thereof, at a pH of about 3.2 to about 5.2 for about 20 minutes to about 16 hours at about 20° C. to about 60° C. to produce an acid whey solution containing at least about 40% less lactose than the original acid whey solution, filtrating said tempered acid whey solution to form a retentate containing proteins and a permeate containing lactose and residual proteins, recovering lactose from said permeate, optionally drying said retentate to form acid whey powder, and (e) optionally texturizing said acid whey powder.

The above method, wherein said acid whey solution is heated to a temperature of about 20° C. to about 60° C. before said at least one enzyme is added to said acid whey solution. The above method, wherein said acid whey solution is heated to a temperature of about 30° C. to about 50° C. The above method, wherein said acid whey solution is heated to a temperature of about 35° C. to about 45° C. The above method, wherein said acid whey solution is heated to a temperature of about 40° C.

The above method, wherein said acid whey solution is treated with said at least one enzyme for about 4 hours to about 14 hours (e.g., 4-14 hours). The above method, wherein said acid whey solution is treated with said at least one enzyme for about 4 hours to about 12 hours (e.g., 4-12 hours). The above method, wherein said acid whey solution is treated with said at least one enzyme for about 4 hours to about 10 hours (e.g., 4-10 hours). The above method, wherein said acid whey solution is treated with said at least one enzyme for about 4 hours to about 8 hours (e.g., 4-8 hours). The above method, wherein said acid whey solution is treated with said at least one enzyme for about 4 hours to about 6 hours (e.g., 4-6 hours).

The above method, wherein said acid whey solution is treated with said at least one enzyme for about 20 minutes to about 4 hours (e.g., 20 minutes to 4 hours). The above method, wherein said acid whey solution is treated with said at least one enzyme for about 20 minutes to about 3 hours (e.g., 20 minutes to 3 hours). The above method, wherein said acid whey solution is treated with said at least one enzyme for about 20 minutes to about 2 hours (e.g., 20 minutes to 2 hours). The above method, wherein said acid whey solution is treated with said at least one enzyme for about 20 minutes to about 60 minutes (e.g., 20-60 minutes). The above method, wherein said acid whey solution is treated with said at least one enzyme for about 20 minutes to about 40 minutes (e.g., 20-40 minutes). The above method, wherein said acid whey solution is treated with said at least one enzyme for about 25 minutes to about 35 minutes (e.g., 25-35 minutes). The above method, wherein said acid whey solution is treated with said at least one enzyme for about 30 minutes (e.g., 30 minutes).

The above method, wherein said acid whey solution is treated with said at least one enzyme at a pH of about 3.2 to about 5.2. The above method, wherein said acid whey solution is treated with said at least one enzyme at a pH of about 4.2.

The above method, wherein said method produces an acid whey solution containing at least about 45% less lactose than the original acid whey solution. The above method, wherein said method produces an acid whey solution containing at least about 50% less lactose than the original acid whey solution. The above method, wherein said method produces an acid whey solution containing at least about 55% less lactose than the original acid whey solution. The above method, wherein said method produces an acid whey solution containing at least about 60% less lactose than the original acid whey solution. The above method, wherein said method produces an acid whey solution containing at least about 65% less lactose than the original acid whey solution. The above method, wherein said method produces an acid whey solution containing at least about 70% less lactose than the original acid whey solution. The above method, wherein said method produces an acid whey solution containing at least about 75% less lactose than the original acid whey solution. The above method, wherein said method produces an acid whey solution containing at least about 80% less lactose than the original acid whey solution,

Process acid whey produced by the above method.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Percent Protein in whey from different treatments.

| | | Raw Acid | Low | High |
|---|---|---|---|---|
| | | Whey | Temperature | Temperature |
| | | Control | Range | Range |
| Protein | Line | (%) | (%) | (%) |
| Unknown 1 | 1 | 0.54 | 0.31 | 0.5 |
| Unknown 2 | 2 | 0.42 | 0.19 | 0.28 |
| Unknown 3 | 3 | 0.27 | 0.15 | 0.18 |
| Unknown 4 | 4 | 0.39 | 0.11 | 0.14 |
| Unknown 5 | 5 | 0.4 | 0.24 | 0.42 |
| Lactoferrin** | 6 | 3.3 | 0.72 | 1.2 |
| Bovine Serum | 7 | 3 | 0.48 | 0.63 |
| Albumin | | | | |
| IgG Heavy Chain | 8 | 3.6 | 0.87 | 1 |
| Unknown 7 | 9 | 0.51 | 0.49 | 0.57 |
| Unknown 8 | 10 | 1.4 | 5.3 | 6.4 |
| a-casein-1 | 11 | 2.9 | 1.4 | 1.2 |
| a-casein-2 | 12 | 1.3 | 1.2 | 1.1 |
| b-casein | 13 | 4.7 | 3.1 | 2.5 |
| k-casein | 14 | 2.7 | 2 | 2.1 |
| Unknown 9 | 15 | 0.61 | 1.5 | 1.5 |
| Unknown 10 | 16 | 2.5 | 3.8 | 3.9 |
| b-lactoglobulin | 17 | 51.3 | 27.2 | 24.1 |
| Unknown 11 | | 0 | 35.9 | 35 |
| Unknown 12 | 18 | 1.2 | 1.2 | 5.7 |
| a-lactalbumin | 19 | 18.7 | 10.2 | 9.7 |
| Unknown 13 | 20 | 0.35 | 2.9 | 1.5 |

We claim:

1. A method for processing acid whey, said method comprising treating acid whey solution with at least one enzyme selected from the group consisting of α-galactosidase, β-galactosidase, and mixtures thereof, at a pH of about 3.2 to about 5.2 for about 20 minutes to about 16 hours at about 20° C. to about 60° C. to produce an acid whey solution containing at least about 40% less lactose than the original acid whey solution, filtrating said tempered acid whey solution to form a retentate containing proteins and a permeate containing lactose and residual proteins, recovering lactose from said permeate, optionally drying said retentate to form acid whey powder, and (e) optionally texturizing said acid whey powder.

2. The method according to claim 1, wherein said acid whey solution is heated to a temperature of about 20° C. to about 60° C. before said at least one enzyme is added to said acid whey solution.

3. The method according to claim 1, wherein said acid whey solution is heated to a temperature of about 30° C. to about 50° C.

4. The method according to claim 1, wherein said acid whey solution is heated to a temperature of about 35° C. to about 45° C.

5. The method according to claim 1, wherein said acid whey solution is heated to a temperature of about 40° C.

6. The method according to claim 1, wherein said acid whey solution is treated with said at least one enzyme for about 4 hours to about 14 hours.

7. The method according to claim 1, wherein said acid whey solution is treated with said at least one enzyme for about 4 hours to about 12 hours.

8. The method according to claim 1, wherein said acid whey solution is treated with said at least one enzyme for about 4 hours to about 10 hours.

9. The method according to claim 1, wherein said acid whey solution is treated with said at least one enzyme for about 4 hours to about 8 hours.

10. The method according to claim 1, wherein said acid whey solution is treated with said at least one enzyme for about 4 hours to about 6 hours.

11. The method according to claim 1, wherein said acid whey solution is treated with said at least one enzyme for about 20 minutes to about 4 hours.

12. The method according to claim 1, wherein said acid whey solution is treated with said at least one enzyme for about 20 minutes to about 3 hours.

13. The method according to claim 1, wherein said acid whey solution is treated with said at least one enzyme for about 20 minutes to about 2 hours.

14. The method according to claim 1, wherein said acid whey solution is treated with said at least one enzyme for about 20 minutes to about 60 minutes.

15. The method according to claim 1, wherein said acid whey solution is treated with said at least one enzyme for about 20 minutes to about 40 minutes.

16. The method according to claim 1, wherein said acid whey solution is treated with said at least one enzyme for about 25 minutes to about 35 minutes.

17. The method according to claim 1, wherein said acid whey solution is treated with said at least one enzyme for about 30 minutes.

18. The method according to claim 1, wherein said acid whey solution is treated with said at least one enzyme at a pH of about 3.2 to about 5.2.

19. The method according to claim 1, wherein said acid whey solution is treated with said at least one enzyme at a pH of about 4.2.

20. The method according to claim 1, wherein said method produces an acid whey solution containing at least about 45% less lactose than the original acid whey solution.

21. The method according to claim 1, wherein said method produces an acid whey solution containing at least about 50% less lactose than the original acid whey solution.

22. The method according to claim 1, wherein said method produces an acid whey solution containing at least about 55% less lactose than the original acid whey solution.

23. The method according to claim 1, wherein said method produces an acid whey solution containing at least about 60% less lactose than the original acid whey solution.

24. The method according to claim 1, wherein said method produces an acid whey solution containing at least about 65% less lactose than the original acid whey solution.

25. The method according to claim 1, wherein said method produces an acid whey solution containing at least about 70% less lactose than the original acid whey solution.

26. The method according to claim 1, wherein said method produces an acid whey solution containing at least about 75% less lactose than the original acid whey solution.

27. The method according to claim 1, wherein said method produces an acid whey solution containing at least about 80% less lactose than the original acid whey solution.

28. Process acid whey produced by the method according to claim 1.
